(19) United States
(12) Patent Application Publication
(10) Pub. No.: US 2025/0062899 A1
(43) Pub. Date: Feb. 20, 2025

(54) QUANTUM COMPUTING-BASED REVERSIBLE POLYNOMIAL SERIES FOR CRYPTOGRAPHIC OPERATIONS

(71) Applicant: Wells Fargo Bank, N.A., San Francisco, CA (US)

(72) Inventors: Richard Orlando Toohey, San Francisco, CA (US); Jeffrey J. Stapleton, O'Fallon, MO (US)

(73) Assignee: Wells Fargo Bank, N.A., San Francisco, CA (US)

(21) Appl. No.: 18/234,257

(22) Filed: Aug. 15, 2023

(51) Int. Cl. H04L 9/32

(52) U.S. Cl. CPC H04L 9/32; G06N 10/00

(57) ABSTRACT

The arrangements of the present disclosure relate to systems, methods, and non-transitory computer-readable media for receiving, from a first computing system, coefficient information comprising coefficients of a polynomial series determined based on an analytical function, wherein the analytical function represents a cryptographic material, determining the analytical function using the coefficient information, determining the cryptographic material using the analytical function, and performing a cryptographic operation using the cryptographic material.

### BACKGROUND

Quantum computers are adapt at solving complex linear equations quickly whereas to perform the same calculations, classical computers require impractical time (e.g., nonpolynomial time), infeasible amounts of memory, and extraordinary huge storage capacities. Thus, classical computers can only determine approximations of complex linear equations. While a classical computer processes bits sequentially, the quantum bits or qubits processed by a quantum computer are entangled together. Changing the state of one qubit influences the state of others regardless of their physical distance. Furthermore, the superposition principle of quantum mechanics allows a qubit to simultaneously store more information than the classical deterministic “0” and “1”. That is, two qubits can simultaneously hold four probabilistic (22) values (e.g., 00, 01, 10, and 11). Thus, a “true” quantum computer that is able to implement both the entanglement and superposition principles can converge on the right answer to a difficult mathematical problem very quickly.

### SUMMARY

The arrangements disclosed herein relate to systems, methods, non-transitory computer-readable media, apparatuses for receiving, from a first computing system, coefficient information comprising coefficients of a polynomial series determined based on an analytical function, wherein the analytical function represents or uses a cryptographic material, determining the analytical function using the coefficient information, determining the cryptographic material using the analytical function, and performing a cryptographic operation using the cryptographic material.

These and other features, together with the organization and manner of operation thereof, will become apparent from the following detailed description when taken in conjunction with the accompanying drawings.

### BRIEF DESCRIPTION OF THE DRAWINGS

FIG. 1 is a system configured for providing quantum computing-based reversible polynomial series for cryptographic operations, according to various arrangements.

FIG. 2 is a flowchart diagram illustrating a method for quantum computing-based reversible polynomial series for cryptographic operations, according to various arrangements.

FIG. 3 is a flowchart diagram illustrating a method for quantum computing-based reversible polynomial series for cryptographic operations, according to various arrangements.

FIG. 4 is a flowchart diagram illustrating a method for quantum computing-based reversible polynomial series for cryptographic operations, according to various arrangements.

### DETAILED DESCRIPTION

Modern cryptography typically occurs in pairs such as encrypt/decrypt or sign/verify where software, firmware or hardware functions are implemented on classical computers (i.e., a computer that processes information according to classical laws of physics). For example, a first classical computer may establish a secure connection with a second classical computer based on a pair of keys (e.g., one private and one public). The first classical computer would encrypt a message (e.g., client data) with the public key and the second classical computer would decrypt the message with the private key. The classical computers may also use the pair of keys to authenticate messages. The first classical computer would sign a message (e.g., client data) with the private key, and the second classical computer would verify the message using the public key. In both instances, the pair of keys are derived from asymmetric algorithms (e.g., Rivest-Shamir-Adleman (RSA), Diffie-Hellman (DH) and Elliptic Curve Cryptography (ECC)) that are based on “difficult” mathematical problems, such as integer factorization and discrete logarithms. Since these mathematical problems are computationally infeasible for a classical computer to solve within an amount of time that is practical for most applications (e.g., financial transactions, etc.), the classical computer is incapable of deriving the private key from the public key, which is a security feature of analytical functions.

The advent of quantum computers with cryptanalytic capabilities to solve these “difficult” mathematical problems threatens many of these asymmetric algorithms. A quantum computer can rapidly solve integer factorization and discrete logarithmic problems to reveal the private key by using a quantum computer algorithm, such as Shor's algorithm. For example, the RSA public key is its modulus which is a product of two prime numbers, N=PQ, but factoring such large numbers is too “difficult” of a mathematical problem for classical computers to solve. On the other hand, a quantum computer running Shor's algorithm can rapidly find P or Q, which reveals the RSA private key, D=(P−1)(Q−1).

The National Institute of Standards and Technology (NIST) is in the process of selecting the generation of public-key cryptographic algorithms through a public competition-like process, referred to as NIST Post-Quantum Cryptography (PQC) Standardization Process. These new public-key cryptography standards will specify one or more additional algorithms in each of digital signature, public-key encryption, key-establishment, and so on. The new standards will augment Federal Information Processing Standard Publication (FIPS) 186-4, Digital Signature Standard (DSS), as well as Special Publications 800-56A Revision 3, Recommendation for Pair-Wise Key Establishment Schemes Using Discrete Logarithm Cryptography, and 800-56B, Recommendation for Pair-Wise Key-Establishment Schemes Using Integer Factorization. The goal of PQC is to develop cryptographic systems that are secure against both quantum and classical computers. While the PQC now in development are QC-resistant cryptographic algorithms that can run on classical computers, the inevitable advances in quantum computer technology will likely make it possible for a quantum computer to solve virtually any cryptographic algorithm.

A Taylor Series Expansion is a tool that can be used in computation and analytic/applied mathematics in relation to encryption. A Taylor Series Expansion of a function ƒ(x) (e.g., an analytical function) can be determined using:

$$f ( x ) = \sum \frac{{f}^{( n )} ( a )}{n !} {( x - a )}^{n} , \qquad ( 1 )$$

where x is the variable of the function ƒ(x), and α is a coefficient. Performing the Tayler Series Expansion transformation of a function is an easy problem for classical computers to solve, given some differentiable function. The Taylor Series Expansion takes any arbitrarily complex, continuously differentiable function and approximates it as a polynomial series. In response to determining the Taylor series of a function, the function can be expressed or represented through knowledge of the coefficients of the series, such as {α₁, α₂, . . . , αₙ}. In some examples, Taylor series are infinite series, and a computer may truncate the series to match a degree of precision. That is, the greater value of n, the less impact the term with n has on the overall precision.

This transformation is considered as a one-way transformation conventionally given that a classical computer finds it very difficult to perform the reverse operation, i.e., to generate the function using the Taylor polynomial series.

The arrangements disclosed herein relate to systems, apparatuses, methods, and non-transitory computer-readable media for performing a cryptographic operation including a reversible polynomial series (e.g., a reversible Taylor series expansion) on a quantum computer. As used herein, a cryptographic material as used herein refers to any tangible information that can be used in cryptographic operations (e.g., cryptographic processes or cryptographic algorithms) to encrypt, decrypt, validate, authenticate, or protect sensitive information. Examples of the cryptographic material include a cryptographic key (e.g., a private key, a secret key, and so on), information (e.g., a secret parameter, a random number, a key component, an initialization vector) used to generate or derive a cryptographic key, authentication code, and so on. The cryptographic material can be expressed using an alphanumeric string, a binary string, and so on. A Taylor series can be used to approximate an analytical function that uses the cryptographic material. Examples of the analytical function includes trigonometric functions, exponents, and so on. In some examples, a Taylor series can be used to approximate an encryption function, a cryptographic signature function, a mathematical calculation (e.g., XOR), an analytic function and so on. For example Hash-based Message Authentication Code (HMAC) uses a hash function with a cryptographic material (e.g., a symmetric key parameter) to generate a Message Authentication Code (MAC) output.

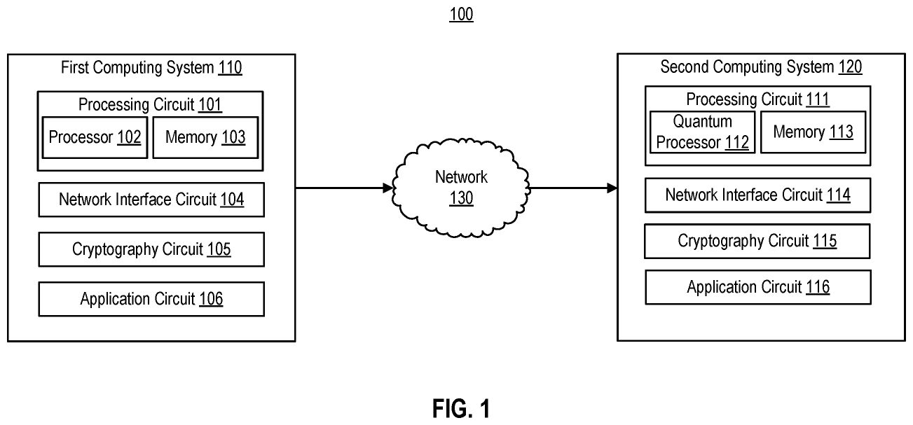

FIG. 1 is a system 100 configured for providing quantum computing-based reversible polynomial series for cryptographic operations, according to various arrangements. The system 100 includes a first computing system 110 and a second computing system 120. In some arrangements, a first computing system 110 (e.g., a classical computer or a quantum computer) can perform a Taylor series expansion on an analytical function corresponding to a cryptographic material to determine coefficients of the resulting Taylor series. The first computing system 110 sends the coefficients via a network 130 to a second computing system 120 (e.g., a quantum computer) via a network. The second computing system 120 can determine the analytical function using the coefficients (e.g., the polynomial series). The second computing system 120 can perform cryptographic operations using the analytical function and cryptographic material, such as encrypting data, decrypting data, encrypt another cryptographic material (e.g., another cryptographic key), decrypting another cryptographic material, sign data, verify data, signcrypt data, and so on, or send the cryptographic material to a third computing system (e.g., classical computer or a quantum computer) so that the third computing system (not shown) can perform those cryptographic operations.

In some arrangements, the first computing system 110 can be any number of different types of classical electronic computing devices, including for example, a personal computer, a laptop computer, a desktop computer, a mobile computer, a tablet computer, a smart phone, an application server, a catalog server, a communications server, a computing server, a database server, a file server, a game server, a mail server, a media server, a proxy server, a virtual server, a web server, or any other type and form of computing device or combinations of devices. In some arrangements, the first computing system 110 can be a quantum computer or a simulated quantum computer as described herein.

The second computing system 120 is a quantum computing device can be any number of different types of quantum computing device, including for example, a superconducting quantum computer, a trapped ion quantum computer, an optical lattice based quantum computer, a quantum dot computer (spin-based or spatial-based), coupled quantum wire, a Nuclear Magnetic Resonance Quantum Computer (NMRQC), a Solid-State Nuclear Magnetic Resonance (NMR) Kane quantum computer, an electrons-on-helium quantum computer, a Cavity Quantum Electrodynamics (CQED) based quantum computer, a molecular magnet-based quantum computer, a fullerene-based Electronic Spin Resonance (ESR) quantum computer, a linear optical quantum computer, a diamond-based quantum computer, a Bose-Einstein condensate-based quantum computer, a transistor-based quantum computer, a rare-earth-metal-ion-doped inorganic crystal based quantum computer, a metallic-like carbon nanospheres based quantum computers, or any other type and form of quantum computing device or combinations of devices.

In some examples, the second computing system 120 can be a simulated quantum computer executing an application that simulates one or more quantum computing operations capable of being performed by a quantum computing device. In some arrangements, a simulated quantum computer processes information and/or performs operations at a rate that is slower than the rate at which a quantum computer performs the same or similar operations due to the differences in performance between conventional processors configured to process logical bits and quantum logic gates configured to process quantum bits or qubits.

The network 130 is structured to permit the exchange of the message. For example, the network 130 can include the Internet, a Radio Frequency (RF) network, a cellular network, a satellite link, a quantum network, an optical network, a laser network, a physical network or connection, and so on. The message can be transmitted via the Internet, RF, and cellular networks, RF signals, cellular signals, satellite signals, quantum bits or qubits, fiber optic signals, laser signals, and so on. The network 130 can include any suitable Local Area Network (LAN), Wide Area Network (WAN), or a combination thereof. For example, the network 130 can be supported by Frequency Division Multiple Access (FDMA), Time Division Multiple Access (TDMA), Code Division Multiple Access (CDMA) (particularly, Evolution-Data Optimized (EVDO)), Universal Mobile Telecommunications Systems (UMTS) (particularly, Time Division Synchronous CDMA (TD-SCDMA or TDS) Wideband Code Division Multiple Access (WCDMA), Long Term Evolution (LTE), evolved Multimedia Broadcast Multicast Services (eMBMS), High-Speed Downlink Packet Access (HSDPA), and the like), Universal Terrestrial Radio Access (UTRA), Global System for Mobile Communications (GSM), Code Division Multiple Access 1× Radio Transmission Technology (lx), General Packet Radio Service (GPRS), Personal Communications Service (PCS), 802.11X, ZigBee, Bluetooth, Wi-Fi, any suitable wired network, combination thereof, and/or the like.

Although not illustrated, in many arrangements, the network 130 can include one or more intermediary devices, including gateways, routers, firewalls, switches, network accelerators, Wi-Fi access points or hotspots, or other devices. Any of the electronic devices and/or the network 130 may be configured to support any application layer protocol, including without limitation, Transport Layer Security (TLS), Hypertext Transfer Protocol (HTTP), and Hypertext Transfer Protocol Secure (HTTPS).

The first computing system 110 includes a processing circuit 101, a network interface circuit 104, a cryptography circuit 105, and an application circuit 106. The second computing system 120 include a processing circuit 111, a network interface circuit 114, a cryptography circuit 115, and an application circuit 116. While various circuits, interfaces, and logic with particular functionality are shown, it should be understood that each of the first computing system 110 or the second computing system 120 can include any number of circuits, interfaces, and logic for facilitating the functions described herein. For example, the activities of multiple circuits may be combined as a single circuit and implemented on a same processing circuit (e.g., processing circuit 101 and 111), as additional circuits with additional functionality are included.

The first computing system 110 includes a processing circuit 101 includes at least one processor 102 and at least one memory 103. A processor 102 may be implemented as a general-purpose processor, a microprocessor, an Application Specific Integrated Circuit (ASIC), one or more Field Programmable Gate Arrays (FPGAs), a Digital Signal Processor (DSP), a group of processing components, or other suitable electronic processing components. In some arrangements, the processor 102 may be a multi-core processor or an array (e.g., one or more) of processors. The processor 102 may be configured to perform classical computations on a bit, which is a binary unit of information equating to one of two possible values (e.g., a ‘0’ or a ‘1’).

The memory 103 (e.g., Random Access Memory (RAM), Read-Only Memory (ROM), Non-volatile RAM (NVRAM), Flash Memory, hard disk storage, optical media, etc.) of processing circuit 101 stores data and/or computer instructions/code for facilitating at least some of the various processes described herein. The memory 103 includes tangible, non-transient volatile memory, or non-volatile memory. The memory 103 stores programming logic (e.g., instructions/code) that, when executed by the processor 102, controls the operations of the first computing system 110. In some arrangements, the processor 102 and the memory 103 form various processing circuits described with respect to the first computing system 110. The instructions include code from any suitable computer programming language such as, but not limited to, C, C++, C#, Java, JavaScript, VBScript, Perl, HTML, XML, Python, TCL, and Basic.

The first computing system 110 includes a network interface circuit 104 configured to establish a communication session with the second computing system 120 for sending and receiving data over the network 130 to or from the second computing system 120. Accordingly, the network interface circuit 104 includes a cellular transceiver (supporting cellular standards), a local wireless network transceiver (supporting 802.11X, ZigBee, Bluetooth, Wi-Fi, or the like), a wired network interface, a combination thereof (e.g., both a cellular transceiver and a Bluetooth transceiver), and/or the like. In some arrangements, the first computing system 110 includes a plurality of network interface circuits 104 of different types, allowing for connections to a variety of networks, such as local area networks or wide area networks including the Internet, via different sub-networks.

The first computing system 110 includes a cryptographic circuit 105 that is configured to perform cryptographic operations of the first computing system 110. For example, the cryptographic circuit 105 can such as encrypting data, decrypting data, encrypting another cryptographic material (e.g., another cryptographic key), decrypting another cryptographic material, signing data, verifying data, signcrypting data, and so on using a cryptographic material. For example, the cryptographic circuit 105 can be configured to encrypt data or decrypt encrypted data using a cryptographic key and a suitable cryptographic algorithm, including an asymmetric cryptographic algorithm (e.g., a Rivest-Shamir-Adleman (RSA) algorithm, a Diffie-Hellman (DH) algorithm, or an Elliptic Curve Cryptography (ECC) algorithm) or a symmetric cryptographic algorithm (e.g., an Advanced Encryption Standard (AES) algorithm, a Data Encryption Standard (DES), Rivest Cipher 4 (RC4), Rivest Cipher 5 (RC5), or Rivest Cipher 6 (RC6)). For example, the cryptographic circuit 105 can be configured to sign or signcrypt data using a cryptographic key.

The cryptographic circuit 105 can generate an analytical function using the cryptographic material. The cryptographic circuit 105 can generate a Taylor series for the analytical function and determine the coefficients of the analytical function. The cryptographic circuit 105 can configure the network interface circuit 104 to send the coefficient information of the analytical function to the second computing system 120. The cryptographic circuit 105 can configure the network interface circuit 104 to send encrypted data or data protected by a digital signature to the second computing system 120, which the second computing system 120 can decrypt or verify using the cryptographic material determined from the coefficient information.

The application circuit 106 executes an application, software, firmware, or code for which cryptographic operations are needed to encrypt data, decrypt data, encrypt another cryptographic material, decrypt another cryptographic material, sign data, verify data, signcrypt data, and so on. For example, the application circuit 106 can execute a mobile banking application, a browser, a word processing application, a mobile banking application, a mobile wallet, a Graphic User Interface (GUI), an email reader/client, a File Transfer Protocol (FTP) client, a virtual machine application and so on.

The processing circuit 111 of the second computing system 120 includes at least one quantum processor 112 and at least one memory 113. The quantum processor 112 can be implemented as one or more quantum logic gates or any other suitable electronic processing component configured to perform quantum computations using quantum bits or qubits. The quantum processor 112 solves mathematical problems (e.g., integer factorization and discrete logarithms) by performing one or more quantum algorithms including algorithms based on quantum Fourier transform (e.g., Deutsch-Jozsa algorithm, Bernstein-Vazirani algorithm, Simon's algorithm, Quantum phase estimation algorithm, Shor's algorithm, Hidden subgroup problem, Boson sampling problem, Estimating Gauss sums, Fourier fishing and Fourier checking), algorithms based on amplitude amplification (e.g., Grover's algorithm, Quantum counting), algorithms based on quantum walks (e.g., element distinctness problem, triangle-finding problem, formula evaluation, group commutativity), and hybrid quantum/classical algorithms (e.g., Quantum Approximate Optimization Algorithm (QAOA), variational quantum Eigensolver, and so on).

The memory 113 of processing circuit 111 stores data and/or computer instructions/code for facilitating at least some of the various processes described herein. The memory 113 is configured to maintain a sequence of qubits representing a one, a zero, or any quantum superposition of those two qubit states. In general, a memory 113 configured to maintain n qubits can be in any superposition of up to 2ⁿ different states. For example, a pair of qubits can be in any quantum superposition of 4 states and three qubits in any superposition of 8 states. Conversely, a classical computer (e.g., the first computing system 110), may only be in one of these 2ⁿ states at any one time.

The network interface circuit 114 configured to establish a communication session with the first computing system 110 for sending and receiving data over the network 130 to or from the second computing system 120. Accordingly, the network interface circuit 114 includes a cellular transceiver (supporting cellular standards), a local wireless network transceiver (supporting 802.11X, ZigBee, Bluetooth, Wi-Fi, or the like), a wired network interface, a combination thereof (e.g., both a cellular transceiver and a Bluetooth transceiver), and/or the like. In some arrangements, the second computing system 120 includes a plurality of network interface circuits 114 of different types, allowing for connections to a variety of networks, such as local area networks or wide area networks including the Internet, via different sub-networks.

The second computing system 120 includes a cryptographic circuit 115 that is configured to perform cryptographic operations of the second computing system 120. For example, the cryptographic circuit 115 can such as encrypting data, decrypting data, encrypting another cryptographic material (e.g., another cryptographic key), decrypting another cryptographic material, signing data, verifying data, signcrypting data, and so on using a cryptographic material. For example, the cryptographic circuit 115 can be configured to encrypt data or decrypt encrypted data using a cryptographic key and a suitable cryptographic algorithm, including an asymmetric cryptographic algorithm or a symmetric cryptographic algorithm. For example, the cryptographic circuit 115 can be configured to sign or signcrypt data using a cryptographic key.

The cryptographic circuit 115 can configure the network interface circuit 114 to receive the coefficient information from the first computing system 110. The cryptographic circuit 115 can determine an analytical function using the coefficient information based on graph similarity algorithm. The cryptographic circuit 115 can determine the cryptographic material using the analytical function and perform a cryptographic operation using the cryptographic material.

The application circuit 116 executes an application, software, firmware, or code for which cryptographic operations are needed to encrypt data, decrypt data, encrypt another cryptographic material, decrypt another cryptographic material, sign data, verify data, signcrypt data, and so on. For example, the application circuit 116 can execute server-side processes for a mobile banking application, a browser, a word processing application, a mobile banking application, a mobile wallet, a GUI, an email reader/client, an FTP client, a virtual machine application and so on.

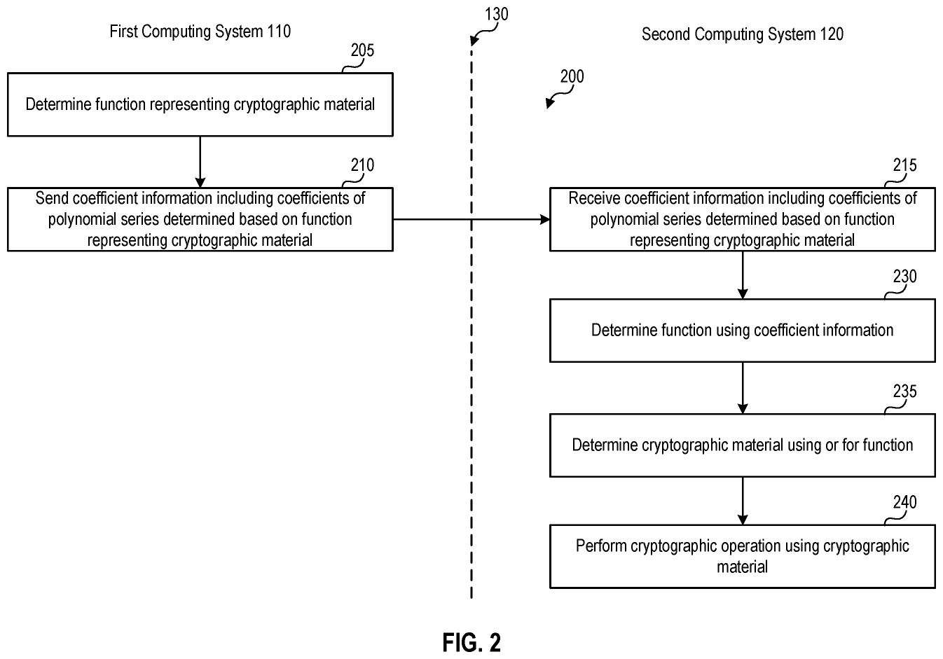

FIG. 2 is a flowchart diagram illustrating a method 200 for quantum computing-based reversible polynomial series for cryptographic operations, according to various arrangements. The method 200 can be performed using the system 100. For example, blocks 205 and 210can be performed by the first computing system 110. Blocks 215, 230, 235, and 240 are performed by the second computing system 120. Communications between the first and second computing systems 110 and 120 via the network 130 are shown as arrows crossing a dashed line representing the network 130. The first computing system 110 includes at least one of a classical computer, a first quantum computer, or a first simulated quantum computer. The second computing system 110 includes at least one of a second quantum computer or a second simulated quantum computer. A quantum computer performs computational processes based on quantum bits or qubits.

At 205, the first computing system 110 (e.g., the cryptographic circuit 105) determines an analytical function representing or using a cryptographic material in a cryptographic operation or process. Examples of the cryptographic material includes information that can be used in cryptographic operations (e.g., cryptographic processes or cryptographic algorithms) to encrypt, decrypt, validate, authenticate, or protect sensitive information. The cryptographic material can be expressed using a string (e.g., an alphanumeric string or a binary string, and so on). That is, the coefficient information includes a string, which includes a plurality of strings, each of the plurality of strings is a string of a respective coefficient of the polynomial series.

The first computing system (e.g., the cryptographic circuit 105) uses or applies a cryptographic material such as a cryptographic key (e.g., a private key) into an analytical function or a series of analytical functions referred to the analytical function or function F(x). This function can be arbitrarily complex as long as the function is indefinitely differentiable and continuous. In some examples, the function can be represented or approximated using a polynomial series such as a Taylor series. For example, the cryptographic circuit 105 can determine the Taylor series expansion of the function. In some examples, the coefficient information includes an alphanumeric string or a binary string of coefficients. For example, the coefficients of the polynomial series, which can be represented as a string of numerals or binaries, can be combined or aggregated (e.g., concatenated) to form the coefficient information, which is itself a string of numerals or binaries.

At 210, the first computing system 110 (e.g., the cryptographic circuit 105 configuring the network interface circuit 104) sends to the second computing system 120 via the network 130 coefficient information including the coefficients of a polynomial series determined based on an analytical function that represents or uses the cryptographic material. At 215, the second computing system (e.g., the cryptographic circuit 115 configuring the network interface circuit 114) receives from the first computing system 110 via the network 130 the coefficient information.

At 230, the second computing system 120 (e.g., the cryptographic circuit 115) determines the function using the coefficient information. First, the cryptographic circuit 115 determines the polynomial series using the coefficient information. The coefficient information can be parsed to obtain the coefficients of the polynomial series. Given that the polynomial series (e.g., the Taylor series) has a known structure (e.g., expression (1)), the cryptographic circuit 115 can plug in the coefficients into the known structure to obtain the polynomial series.

The cryptographic circuit 115 can determine the function using the polynomial series, using a graph similarity algorithm and an optimization algorithm. In some arrangements, a quantum computer such as the second computing system 120 can perform a graph similarity algorithm using the polynomial series as input to generate a graph kernel. The graph kernel is a measure of how similar two graphs are to each other. The smaller the kernel, the more similar the graphs. The graph similarity algorithm is a quantum algorithm used to measure the similarities between two graphs, one of which is the graph of the polynomial series, and another one of which is a graph of a function. Two graphs are first merged using connections between nodes of the two graphs. The merged structure is analyzed using continuous-time quantum walks and quantum Jensen-Shannon divergence. An example of the graph similarity algorithm is described in Rossi et al., “Measuring Graph Similarity Through Continuous-Time Quantum Walks and The Quantum Jensen-Shannon Divergence,” Phys. Rev. E 91, 022815 (Feb. 23, 2015).

To recreate a function, the graph kernel is minimized by estimating or guessing the most optimal matching graph. This reduces the problem to the Traveling Salesman Problem (TSP) in combinatorial optimization, which can be efficiently solved on quantum computers by using the phase estimation algorithm. An example of resolving the TSP problem using phase estimation algorithm is described in Srinivasan, et al., “Efficient Quantum Algorithm for Solving Travelling Salesman Problem: An IBM Quantum Experience,” arXiv preprint arXiv:1805.10928 (2018). Accordingly, the phase estimation algorithm can be applied to optimize the minimization of the graph kernel.

For example, the cryptographic circuit 115 provides an arbitrary guess by selecting one function of a plurality of known functions. The cryptographic circuit 115 calculates the initial kernel k₀ between the polynomial series and the selected function using graph similarity algorithm. The cryptographic circuit 115 then minimizes the initial kernel k₀ using an optimization algorithm (e.g., phase estimation algorithm) for combinatorial optimization. The possible combination of functions are the combinatorial in the optimization algorithm. The function of the plurality of known functions that yields the lowest kernel is selected to be the function corresponding ot the coefficient information.

At 235, the second computing system 120 (e.g., the cryptographic circuit 115) determines the cryptographic material using or for the function. In some arrangements, the cryptographic material can be mapped to or associated with the function. For example, the cryptographic material can be a type of cryptographic material that is used in the function (e.g., the analytic function such as trigonometric functions, exponents, and so on) determined at 230. Based on predefine mapping, a cryptographic material or a type of cryptographic materials corresponding to the function can be determined. In some examples, the function determined at 230 can be executed or performed to calculate by the second computing system 120 (e.g., the cryptographic circuit 115) to generate the cryptographic material or a component thereof, which is used to derive the cryptographic material. For example, the second computing system 120 (e.g., the cryptographic circuit 115) can plug in at least one parameters (e.g., a seed, a salt, a secret parameter, a random number, and so on) into the function to generate the cryptographic material.

At 240, the second computing system 120 (e.g., the cryptographic circuit 115) performs a cryptographic operation using the cryptographic material and the analytic function. Examples of cryptographic operations that can be performed by the second computing system 120 include (e.g., the cryptographic circuit 115) encrypting data, decrypting data, encrypting another cryptographic material (e.g., another cryptographic key), decrypting another cryptographic material, signing data, verifying data, signcrypting data, and so on using a cryptographic material. In some examples, the second computing system 120 can use the result of the cryptographic operation (e.g., encrypted data, decrypted data, signed data, verified data, signcrypted data) for the application executed by the application circuit 116, for verification, authentication, and communications. In some examples, the second computing system 120 can forward or relay the result of the cryptographic operation to the third computing system for an application executed thereon. In some examples, the second computing system 120 (e.g., the cryptographic circuit 115) can encrypt, sign, signcrypt other data using the cryptographic material. In some examples, the second computing system 120 (e.g., the cryptographic circuit 115) can derive a cryptographic key using the cryptographic material, and use the derived cryptographic key to perform cryptographic operations described herein.

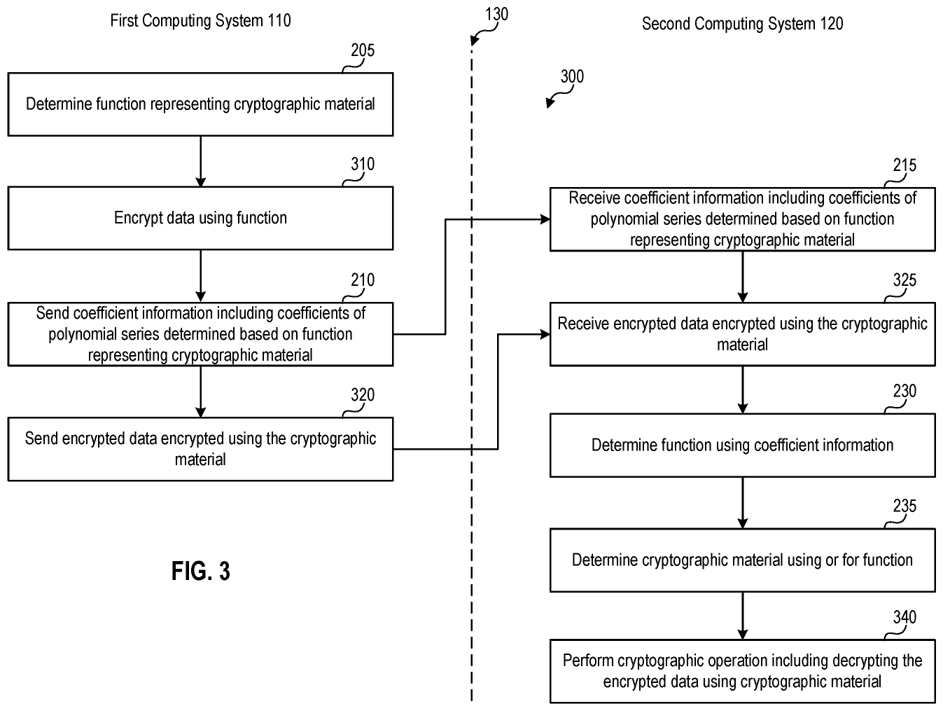

FIG. 3 is a flowchart diagram illustrating a method 300 for quantum computing-based reversible polynomial series for cryptographic operations (e.g., data encryption and decryption), according to various arrangements. The method 300 can be performed using the system 100. For example, blocks 205, 310, 210, and 320 can be performed by the first computing system 110. Blocks 215, 325, 230, 235, and 340 are performed by the second computing system 120. Communications between the first and second computing systems 110 and 120 via the network 130 are shown as arrows crossing a dashed line representing the network 130. The first computing system 110 includes at least one of a classical computer, a first quantum computer, or a first simulated quantum computer. The second computing system 110 includes at least one of a second quantum computer or a second simulated quantum computer. A quantum computer performs computational processes based on quantum bits or qubits.

For example, at 205, a function representing or using the cryptographic material is determined, as described relative to FIG. 2. In some examples, the function can be a function used in an encryption process, such as an encryption function. The cryptographic material can include a cryptographic key. The cryptographic key can be a symmetric or asymmetric private key.

At 310, the first computing system 110 (e.g., the cryptographic circuit 105) encrypts data using a function. For example, the first computing system 110 (e.g., the cryptographic circuit 105) encrypts data using an encryption function and a cryptographic material such as a cryptographic key. In a symmetric cryptographic algorithm, the cryptographic key used to encrypt the data in 310 includes a symmetric private key. In an asymmetric cryptographic algorithm, the cryptographic key used to encrypt the data in 310 includes a public key of the first computing system 110.

At 210, as described relative to FIG. 2, the first computing system 110 (e.g., the cryptographic circuit 105 configuring the network interface circuit 104) sends to the second computing system 120 via the network 130 coefficient information including the coefficients of a polynomial series determined based on an analytical function that represents or uses the cryptographic material. At 215, as described relative to FIG. 2, the second computing system (e.g., the cryptographic circuit 115 configuring the network interface circuit 114) receives from the first computing system 110 via the network 130 the coefficient information. The cryptographic material in 210 and 215 includes a symmetric private key or an asymmetric private key.

At 320, the first computing system 110 (e.g., the cryptographic circuit 105 configuring the network interface circuit 104) sends to the second computing system 120 via the network 130 encrypted data that is encrypted at 310. The encrypted data can be encrypted using a symmetric private key (same as the symmetric private key in 210 and 215) or a public key in an asymmetric algorithm.

At 230, as described relative to FIG. 2, the second computing system 120 (e.g., the cryptographic circuit 115) determines the function using the coefficient information. At 235, as described relative to FIG. 2, the second computing system 120 (e.g., the cryptographic circuit 115) determines the cryptographic material using or for the function. The cryptographic material determined in 235 includes a symmetric private key or an asymmetric private key.

At 340, the second computing system 120 (e.g., the cryptographic circuit 115) performs a cryptographic operation including decrypting the encrypted data using the cryptographic material determined at 235. For a symmetric encryption algorithm, the second computing system 120 decrypts the encrypted data received at 325 using the symmetric private key, which is used to encrypt the data at 310 by the first computing system 110. For an asymmetric encryption algorithm, the second computing system 120 decrypts the encrypted data received at 325 using a private key, which is mathematically related to the public key used to encrypt the data at 310 by the first computing system 110. In an asymmetric encryption algorithm, the public key used to encrypt at 310 and the private key used to decrypt at 340 form a public/private key pair.

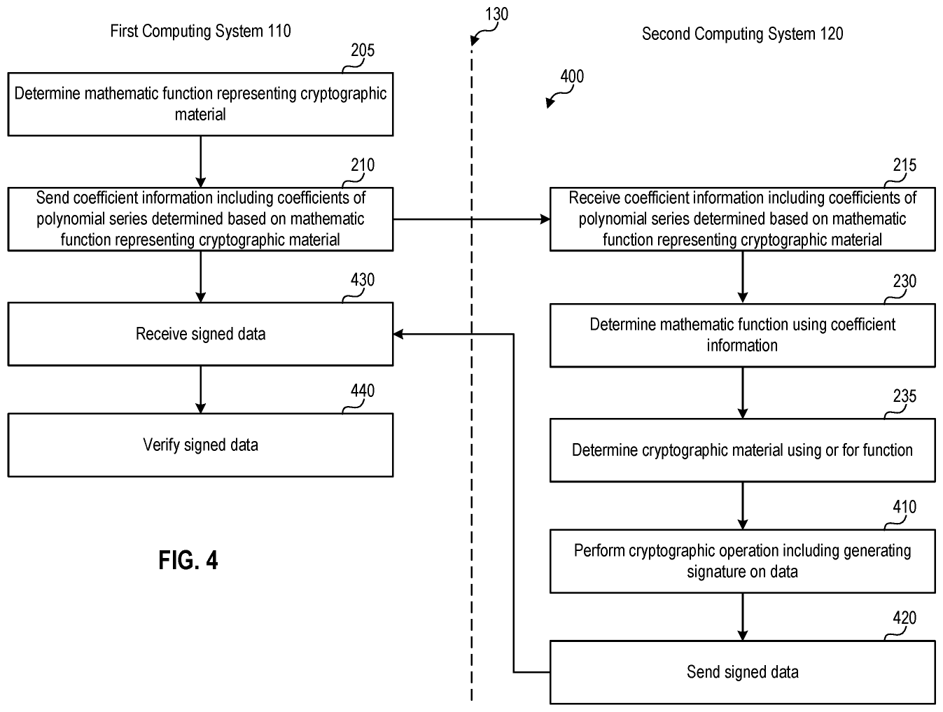

FIG. 4 is a flowchart diagram illustrating a method 400 for quantum computing-based reversible polynomial series for cryptographic operations (e.g., signature generation and verification), according to various arrangements. The method 400 can be performed using the system 100. For example, blocks 205, 210, 430, and 440 can be performed by the first computing system 110. Blocks 215, 230, 235, 410, and 420 are performed by the second computing system 120. Communications between the first and second computing systems 110 and 120 via the network 130 are shown as arrows crossing a dashed line representing the network 130. The first computing system 110 includes at least one of a classical computer, a first quantum computer, or a first simulated quantum computer. The second computing system 110 includes at least one of a second quantum computer or a second simulated quantum computer. A quantum computer performs computational processes based on quantum bits or qubits.

For example, at 205, a function representing or using the cryptographic material is determined, as described relative to FIG. 2. In some examples, the function can be a function used in a digital signature process, such as a digital signature function. The cryptographic material can include a cryptographic key. The cryptographic key can be a private key used in a symmetric signature algorithm or a private key used in an asymmetric signature algorithm.

At 210, as described relative to FIG. 2, the first computing system 110 (e.g., the cryptographic circuit 105 configuring the network interface circuit 104) sends to the second computing system 120 via the network 130 coefficient information including the coefficients of a polynomial series determined based on an analytical function that represents or uses the cryptographic material. At 215, as described relative to FIG. 2, the second computing system (e.g., the cryptographic circuit 115 configuring the network interface circuit 114) receives from the first computing system 110 via the network 130 the coefficient information. The cryptographic material in 210 and 215 includes the private key used in a symmetric signature algorithm or the private key used in an asymmetric signature algorithm, discussed relative to 205.

At 230, as described relative to FIG. 2, the second computing system 120 (e.g., the cryptographic circuit 115) determines the function using the coefficient information. At 235, as described relative to FIG. 2, the second computing system 120 (e.g., the cryptographic circuit 115) determines the cryptographic material using or for the function. The cryptographic material determined in 235 includes the private key used in a symmetric signature algorithm or the private key used in an asymmetric signature algorithm, discussed relative to 205.

At 410, the second computing system 120 (e.g., the cryptographic circuit 115) performs a cryptographic operation including generating a signature on data using the cryptographic material determined at 235. For a symmetric signature algorithm and an asymmetric signature algorithm, the second computing system 120 generates a digital signature on data using the private key. At 420, the second computing system (e.g., the cryptographic circuit 115 configuring the network interface circuit 114) sends to the first computing system 110 via the network 130 the signed data. At 430, the first computing system 110 (e.g., the cryptographic circuit 105 configuring the network interface circuit 104) receives from the second computing system 120 via the network 130 the signed data.

At 440, the first computing system (e.g., the cryptographic circuit 105) verifies the signed data. For a symmetric signature algorithm, the first computing system 120 (e.g., the cryptographic circuit 105) verifies the signature on the signed data using the same private key used to sign the data at 410. For an asymmetric signature algorithm, the first computing system 120 (e.g., the cryptographic circuit 105) verifies the signature on the signed data using a public key, which is mathematically related to the private key used to sign the data at 410 by the second computing system 120. In an asymmetric signature algorithm, the public key used to verify the signature at 440 and the private key used to sign the data at 410 form a public/private key pair.

The data that is encrypted, signed, or signcrypted includes personal or sensitive information such as Social Security Numbers (SSN), passport numbers, addresses, email addresses, phone numbers, Deoxyribonucleic Acid (DNA) information, financial account numbers, usernames, passwords, biometric information, geolocation data, photographs of people, criminal records, credit and/or payment card numbers, health data, certificates, other cryptographic materials such as cryptographic keys, and so on.

Accordingly, the arrangements disclosed herein improve the security and efficiency of cryptographic processes of classical computers by implementing a combination of quantum algorithms running on a quantum computer or a simulated quantum computer. Cryptographic material can be conveyed from the first computing system to the second computing system by transferring coefficients of a polynomial series (e.g., a Taylor series), and the second computing system can re-generate the cryptographic material on its end using a combination of the graph similarity algorithm and an optimization algorithm. The second computing system can serve as a cryptographic interface for a third computing system, which can use the cryptographic materials. Traditional systems cannot implement such a mechanism given that classical computers cannot regenerate the cryptographic material using only the coefficients.

As utilized herein, the terms “approximately,” “substantially,” and similar terms are intended to have a broad meaning in harmony with the common and accepted usage by those of ordinary skill in the art to which the subject matter of this disclosure pertains. It should be understood by those of ordinary skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

Although only a few arrangements have been described in detail in this disclosure, those skilled in the art who review this disclosure will readily appreciate that many modifications are possible (e.g., variations in sizes, dimensions, structures, shapes, and proportions of the various elements, values of parameters, mounting arrangements, use of materials, colors, orientations, etc.) without materially departing from the novel teachings and advantages of the subject matter described herein. For example, elements shown as integrally formed may be constructed of multiple components or elements, the position of elements may be reversed or otherwise varied, and the nature or number of discrete elements or positions may be altered or varied. The order or sequence of any method processes may be varied or re-sequenced according to alternative arrangements. Other substitutions, modifications, changes, and omissions may also be made in the design, operating conditions and arrangement of the various exemplary arrangements without departing from the scope of the present disclosure.

The arrangements described herein have been described with reference to drawings. The drawings illustrate certain details of specific arrangements that implement the systems, methods and programs described herein. However, describing the arrangements with drawings should not be construed as imposing on the disclosure any limitations that may be present in the drawings.

It should be understood that no claim element herein is to be construed under the provisions of 35 U.S.C. § 112(f), unless the element is expressly recited using the phrase “means for.”

As used herein, the term “circuit” may include hardware structured to execute the functions described herein. In some arrangements, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some arrangements, a circuit may take the form of one or more analog circuits, electronic circuits (e.g., integrated circuits (IC), discrete circuits, system on a chip (SOCs) circuits, etc.), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on).

The “circuit” may also include one or more processors communicatively coupled to one or more memory or memory devices. In this regard, the one or more processors may execute instructions stored in the memory or may execute instructions otherwise accessible to the one or more processors. In some arrangements, the one or more processors may be embodied in various ways. The one or more processors may be constructed in a manner sufficient to perform at least the operations described herein. In some arrangements, the one or more processors may be shared by multiple circuits (e.g., circuit A and circuit B may include or otherwise share the same processor which, in some example arrangements, may execute instructions stored, or otherwise accessed, via different areas of memory). Alternatively or additionally, the one or more processors may be structured to perform or otherwise execute certain operations independent of one or more co-processors. In other example arrangements, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some arrangements, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud based server). To that end, a “circuit” as described herein may include components that are distributed across one or more locations.

An exemplary system for implementing the overall system or portions of the arrangements might include a general purpose computing computers in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), a distributed ledger (e.g., a blockchain), etc. In some arrangements, the non-volatile media may take the form of ROM, flash memory (e.g., flash memory such as NAND, 3D NAND, NOR, 3D NOR, etc.), EEPROM, MRAM, magnetic storage, hard discs, optical discs, etc. In other arrangements, the volatile storage media may take the form of RAM, TRAM, ZRAM, etc. Combinations of the above are also included within the scope of machine-readable media. In this regard, machine-executable instructions include, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components, etc.), in accordance with the example arrangements described herein.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative arrangements. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web arrangements of the present disclosure could be accomplished with standard programming techniques with rule based logic and other logic to accomplish the various database searching steps, correlation steps, comparison steps and decision steps.

The foregoing description of arrangements has been presented for purposes of illustration and description. It is not intended to be exhaustive or to limit the disclosure to the precise form disclosed, and modifications and variations are possible in light of the above teachings or may be acquired from this disclosure. The arrangements were chosen and described in order to explain the principals of the disclosure and its practical application to enable one skilled in the art to utilize the various arrangements and with various modifications as are suited to the particular use contemplated. Other substitutions, modifications, changes and omissions may be made in the design, operating conditions and arrangement of the arrangements without departing from the scope of the present disclosure as expressed in the appended claims.

What is claimed is:

1. A system, comprising:
a memory; and
a processor coupled to the memory and configured to:
receive, from a first computing system, coefficient information comprising coefficients of a polynomial series determined based on an analytical function, wherein the analytical function represents or uses a cryptographic material;
determine the analytical function using the coefficient information;
determine the cryptographic material using the analytical function; and
perform a cryptographic operation using the cryptographic material.

2. The system of claim 1, wherein
the first computing system comprises at least one of a classical computer or a first quantum computer; and
the second computing system comprises a second quantum computer.

3. The system of claim 1, wherein each of the first quantum computer or the second quantum computer processes quantum bits or qubits.

4. The system of claim 1, wherein
the cryptographic material comprises a cryptographic key or information used to derive a cryptographic key; and
the cryptographic material is expressed using a string.

5. The system of claim 1, wherein
the polynomial series comprises a Taylor series; and
the polynomial series is determined by performing a Taylor series expansion of the analytical function.

6. The system of claim 1, wherein
the coefficient information comprises a string;
the string comprises a plurality of strings, each of the plurality of strings is a string of a respective coefficient.

7. The system of claim 1, wherein the polynomial series comprises a Taylor series.

8. The system of claim 1, wherein determining the analytical function using the coefficient information comprises:
determining the polynomial series using the coefficient information; and
determining the analytical function using the polynomial series.

9. The system of claim 8, wherein determining the analytical function using the polynomial series comprises:
determining a graph kernel using the polynomial series as an input to a graph similarity algorithm; and
optimizing the graph kernel using a phase estimation algorithm.

10. The system of claim 1, wherein the processor is further configured to receive encrypted data from the first computing system, wherein the cryptographic operation comprises decrypting the encrypted data using the cryptographic material, wherein the cryptographic material comprises a private key.

11. The system of claim 1, wherein the cryptographic operation comprises generate signed data by generating a signature on data using the cryptographic material, wherein the cryptographic material comprises a private key, and wherein the processor is further configured to send the signed data comprising the signature to the first computing system, wherein the first computing system verifies the signature using the private key or a public key corresponding to the private key.

12. A method, comprising:
receiving, from a first computing system, coefficient information comprising coefficients of a polynomial series determined based on an analytical function, wherein the analytical function represents or uses a cryptographic material;
determining the analytical function using the coefficient information;
determining the cryptographic material using the analytical function; and
performing a cryptographic operation using the cryptographic material.

13. The method of claim 12, wherein
the first computing system comprises at least one of a classical computer or a first quantum computer; and
the second computing system comprises a second quantum computer.

14. The method of claim 12, wherein
the cryptographic material comprises a cryptographic key or information used to derive a cryptographic key; and
the cryptographic material is expressed using a string.

15. The method of claim 12, wherein
the polynomial series comprises a Taylor series; and
the polynomial series is determined by performing a Taylor series expansion of the analytical function.

16. The method of claim 12, wherein
the coefficient information comprises a string;
the string comprises a plurality of strings, each of the plurality of strings is a string of a respective coefficient.

17. The method of claim 12, wherein the polynomial series comprises a Taylor series.

18. The method of claim 12, wherein determining the analytical function using the coefficient information comprises:
determining the polynomial series using the coefficient information; and
determining the analytical function using the polynomial series.

19. The method of claim 18, wherein determining the analytical function using the polynomial series comprises:
determining a graph kernel using the polynomial series as an input to a graph similarity algorithm; and
optimizing the graph kernel using a phase estimation algorithm.

20. At least one non-transitory computer-readable medium storing quantum computer readable instructions, such that, when executed, causes at least one quantum processor to perform at least one of:
Receive, from a first computing system, coefficient information comprising coefficients of a polynomial series determined based on an analytical function, wherein the analytical function represents or uses a cryptographic material;
determine the analytical function using the coefficient information;
determining the cryptographic material using the analytical function; and
performing a cryptographic operation using the cryptographic material
